(19) United States
(12) Patent Application Publication
(10) Pub. No.: US 2010/0072014 A1
(43) Pub. Date: Mar. 25, 2010

(54) TWO PIECE IMPELLER HUB FOR HYBRID TORQUE CONVERTER

(75) Inventors: Gregory HEEKE, Wooster, OH (US); Eugen KOMBOWSKI, Buehl (DE)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/562,367

(22) Filed: Sep. 18, 2009

Related U.S. Application Data
(60) Provisional application No. 61/192,764, filed on Sep. 22, 2008.

(51) Int. Cl. F16D 33/00; F16D 47/02; B23P 11/00

(52) U.S. Cl. 192/3.29; 192/208; 192/3.21; 29/889.5

(57) ABSTRACT

An impeller hub assembly including a first portion connected to a rotor for an electric motor, a second portion connected to an impeller shell of a torque converter, and a rotary shaft seal for hydraulically sealing at least one of the first and second portions of the impeller hub assembly to a housing for the torque converter. The assembly may further include a dynamic seal, a hydraulic chamber at least partially enclosed by the rotary shaft seal and the dynamic seal, and a hydraulic channel in fluid communication with the chamber. In some example embodiments of the invention, the hydraulic channel is for lowering pressure in the chamber by providing a discharge path for fluid in the chamber.

### CROSS-REFERENCE TO RELATED APPLICATIONS

This application claims the benefit under 35 U.S.C. §119(e) of U.S. Provisional Application No. 61/192,764, filed Sep. 22, 2008, which application is incorporated herein by reference in its entirety.

### FIELD OF THE INVENTION

The invention relates generally to an impeller hub, and more specifically to a two piece impeller hub for a hybrid torque converter.

### BACKGROUND OF THE INVENTION

Torque converter impeller hubs are designed to hydraulically seal a torque converter to a transmission, and to energize a transmission pump which produces pressure to engage clutches in the transmission. Unfortunately, impeller hubs are generally fixedly attached to a housing of the torque converter and incorporate low pressure rotating seals to seal the torque converter to the transmission. In conventional automotive powertrain applications, the housing must spin in order to drive the transmission pump.

### BRIEF SUMMARY OF THE INVENTION

Example aspects of the present invention comprise an impeller hub assembly including a first portion connected to a rotor for an electric motor, a second portion connected to an impeller shell of a torque converter, and a rotary shaft seal for hydraulically sealing at least one of the first and second portions of the impeller hub assembly to a housing for the torque converter. The assembly may further include a dynamic seal, a hydraulic chamber at least partially enclosed by the rotary shaft seal and the dynamic seal, and a hydraulic channel in fluid communication with the chamber. In some example embodiments of the invention, the hydraulic channel is for lowering pressure in the chamber by providing a discharge path for fluid in the chamber.

Also, in some example embodiments of the invention, the first and second portions include respectively overlapping segments forming at least a portion of the hydraulic channel. The assembly may further include a sleeve installed into the first or second portion of the impeller hub and forming at least a portion of the hydraulic channel. The first and second portions of the impeller hub may include respective radially displaced holes in fluid communication.

In some example embodiments of the invention, a clutch is disposed in a torque path between the second portion and the housing. Also, in some example embodiments of the invention, the first portion is for radially positioning the rotor relative to a transmission. The first portion may be radially positioned by a bearing or bushing disposed in the transmission. Also, a stator of the electric motor may be disposed in the transmission.

Further example aspects of the invention comprise a torque converter including an impeller hub drivingly engaged with an electric motor, and a housing that can be rotationally connected and disconnected from the impeller hub. In some example embodiments of the invention, the torque converter includes a hydraulic seal assembly between the housing and the hub, and a rotary shaft seal for forming a first portion of the seal assembly. The torque converter may further include a dynamic seal for forming a second portion of the seal assembly.

Also, in some example embodiments of the invention, the torque converter further includes a transmission hub fixedly attached to an electric motor and radially positioned by a bearing or a bushing disposed in a transmission. The impeller hub and the transmission hub may be drivingly engaged.

An example method of the invention comprises installing a stator for an electric motor in a transmission, affixing a first impeller hub to a rotor for the electric motor, and installing the rotor into the stator and radially positioning the hub in the transmission. The method may also include affixing a second impeller hub to the torque converter and connecting the first and second impeller hubs so they are drivingly engaged.

A better understanding of these and other aspects, features, and advantages of the invention may be had by reference to the drawings and to the accompanying description, in which example embodiments of the invention are illustrated and described.

### BRIEF DESCRIPTION OF THE DRAWINGS

The nature and mode of operation of example aspects of the present invention will now be more fully described in the following detailed description of the invention taken with the accompanying drawing figures in which:

FIG. 1 is a top-half section view of a torque converter according to a first example embodiment of the invention shown installed in a transmission;

FIG. 2 is a detailed view of encircled region 2 in FIG. 1; and

FIG. 3 is a top-half section view of a torque converter according to a second example embodiment of the invention shown installed in a transmission.

### DETAILED DESCRIPTION OF THE INVENTION

At the outset, it should be appreciated that like drawing numbers on different drawing views identify identical, or functionally similar, structural element of the invention. Furthermore, it is understood that this invention is not limited to the particular embodiments, methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following methods, devices, and materials are now described.

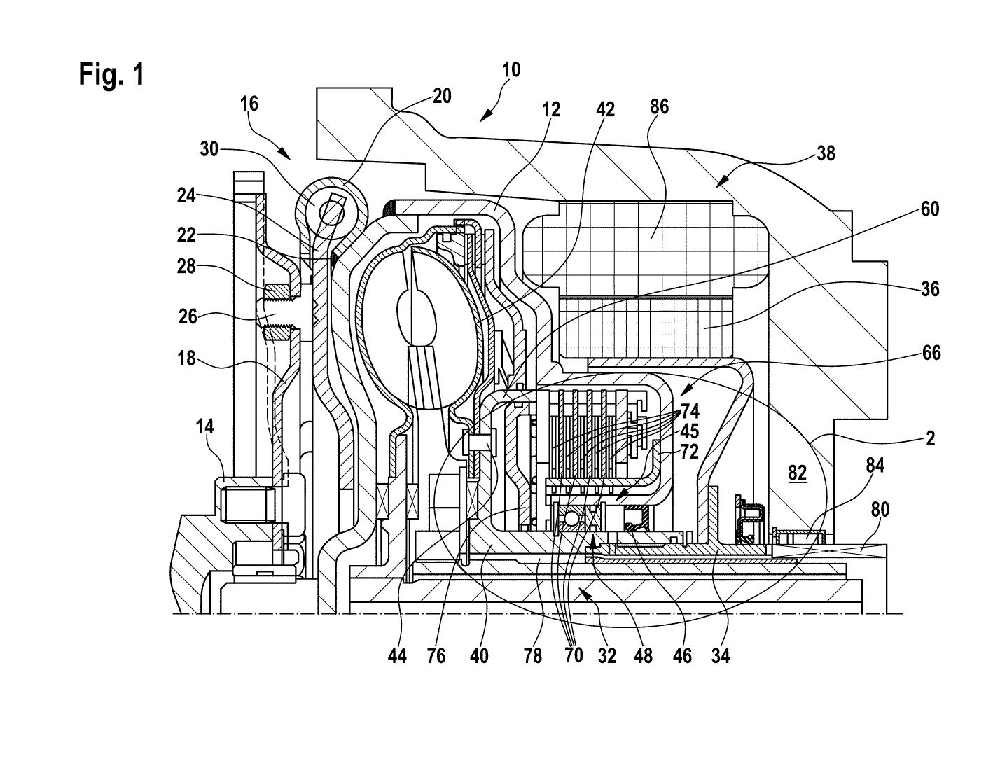

FIG. 1 is a top-half section view of a torque converter according to a first example embodiment of the invention shown installed in a transmission. The following description is made with reference to FIG. 1. Torque converter 10 includes housing 12 connected to engine crankshaft 14 through damper assembly 16 and flexplate 18. Spring retainer 20 of damper assembly 16 is attached to housing 12 with weld 22. Flange 24 of assembly 16 is bolted to flexplate 18 with stud 26 and nut 28. Spring 30 is drivingly engaged with retainer 20 and flange 24. Torque converter 10 is connected to a transmission (partially shown) disposed in a vehicle (not shown) as described below.

Converter 10 includes impeller hub assembly 32. Assembly 32 includes portion 34 connected to rotor 36 for electric motor 38. Portion 40 of assembly 32 is connected to impeller shell 42 of torque converter 10 by rivet 44, for example. Rotary shaft seal 46 hydraulically seals portion 40 to housing 12 of torque converter 10. Rotary shaft seals typically include a sprung main sealing lip with an air side angle and an oil side angle forming a point contact with the shaft. An example rotary shaft seal is shown in FIG. 4 and described in col. 3, lines 1-7 of U.S. Pat. No. 5,980,208, issued Nov. 9, 1999 to Szuba, incorporated herein by reference.

Rotary shaft seal 46 is employed to seal housing 12 to portion 40, in particular while there is relative rotation between the components. For example, if engine crankshaft 14 and housing 12 are stationary, rotary shaft seal 46 maintains a hydraulic seal if portion 40 is rotated by rotor 36.

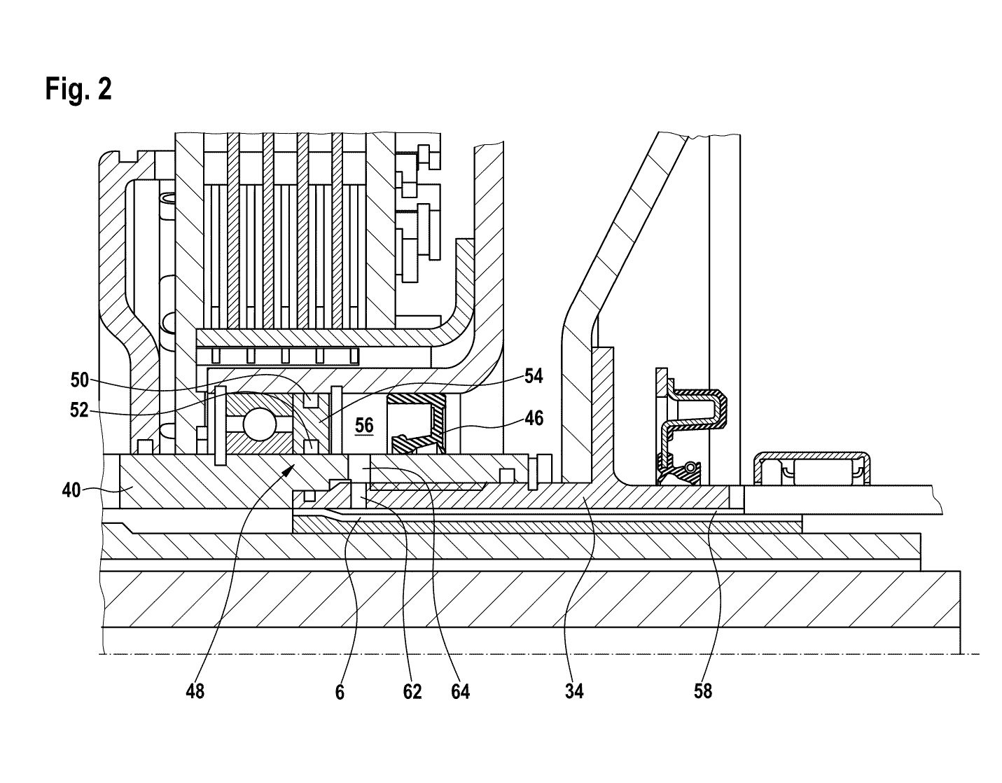

FIG. 2 is a detailed view of encircled region 2 in FIG. 1. The following description is made with reference to FIGS. 1 and 2. Assembly 32 includes dynamic seal 48. Seal 48 includes seals 50 and 52, and piston 54, for example. Seals 50 and 52 may be Teflon seals, for example. Hydraulic chamber 56 is partially enclosed by rotary shaft seal 46 and dynamic seal 48. Hydraulic channel 58 is in fluid communication with chamber 56.

It is desirable to maintain a liquid-tight seal between housing 12 and hub 34. Housing 12 contains hydraulic fluid for operating converter 10 and the transmission. If the seal is not liquid-tight, it may be necessary to replace hydraulic fluid leaked through the seal in order to ensure proper operation of converter 10 and the transmission. Although converter 10 is disposed in a transmission bell housing (partially shown), the bell housing is generally not sealed to the engine (not shown). Therefore, leakage at the interface between housing 12 and hub 34 may result in hydraulic fluid contamination of the area near the bell housing and in adjoining areas, for example, surfaces below the housing. Rotary shaft seal 46 advantageously provides a liquid-tight seal between housing 12 and hub 34.

Although rotary shaft seal 46 forms a hydraulic seal, the seal may be compromised when increased hydraulic pressure present in converter 10 acts on seal 46. Dynamic seal 48 is designed to operate at the higher pressures associated with operation of converter 10 and can substantially contain the hydraulic pressure during operation of converter 10, but dynamic seal 48 is not an absolute seal and allows some leakage of hydraulic fluid into chamber 56. If allowed to accumulate, fluid in chamber 56 could build pressure in chamber 56 and compromise rotary shaft seal 46, which is not designed to operate at the higher pressures associated with operation of converter 10. Advantageously, hydraulic channel 58 is for lowering pressure in chamber 56 by providing a discharge path for fluid (not shown) in chamber 56. Channel 58 may be in fluid communication with a sump (not shown) for the transmission, for example.

Sleeve 60 is installed into portion 34 by press fitting, for example. In an example embodiment (not shown), sleeve 60 is installed into portion 40. Sleeve 60 forms a portion of hydraulic channel 58. Portion 34 and portion 40 include radially displaced holes 62 and 64, respectively. Holes 62 and 64 are in fluid communication. Fluid communication may be direct if the holes are at least partially radially aligned or indirect via an intermediate channel (not shown).

Clutch 66 is disposed in a torque path between portion 40 and housing 12. Portion 40 includes outer carrier 68 engaged with clutch plates 70. Housing 12 includes inner carrier 72 engaged with friction plates 74. Hydraulic pressure acting on piston 76 through channel 78 drivingly engages and disengages portion 40 and housing 12.

In one embodiment, portion 34 is for radially positioning rotor 36 relative to transmission 82, as described below. Portion 34 is connected to rotor 36 and includes bearing surface 80. Surface 80 is installed into bearing 84. Portion 34 is radially positioned by bearing 84 disposed in transmission 82. Therefore, rotor 36 is radially positioned relative to transmission 82 by bearing 84 and portion 34. Stator 86 of electric motor 38 is disposed in transmission 82.

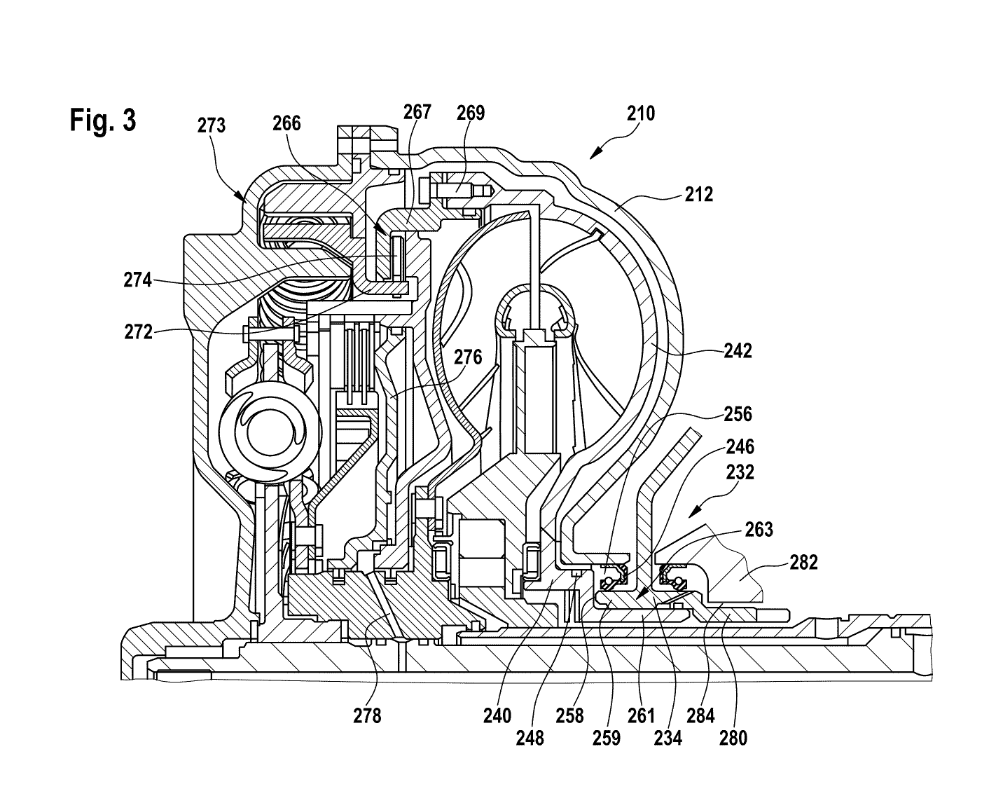

FIG. 3 is a top-half section view of a torque converter according to a second example embodiment of the invention shown installed in a transmission. The following description is made with reference to FIG. 3. Torque converter 210 includes housing 212 connected to an engine crankshaft (not shown). Torque converter 210 is connected to a transmission (partially shown) disposed in a vehicle (not shown) as described below.

Converter 210 includes impeller hub assembly 232. Assembly 232 includes portion 234 connected to a rotor (not shown) for an electric motor (not shown). Portion 240 of assembly 232 is connected to impeller shell 242 of torque converter 210 by welding, for example. Rotary shaft seal 246 hydraulically seals portion 234 to housing 212 of torque converter 210. Rotary shaft seal 246 is employed to permit relative rotation between housing 212 and portion 234. For example, if the engine crankshaft (not shown) and housing 212 are stationary, rotary shaft seal 246 maintains a hydraulic seal if portion 234 is rotated by rotor (not shown).

Assembly 232 includes dynamic seal 248. Seal 248 may be Teflon seal, for example. Hydraulic chamber 256 is partially enclosed by rotary shaft seal 246 and dynamic seal 248. Hydraulic channel 258 is in fluid communication with chamber 256.

It is desirable to maintain a liquid-tight seal between housing 212 and hub 234. Housing 212 contains hydraulic fluid for operating converter 210 and the transmission. If the seal is not liquid-tight, it may be necessary to replace hydraulic fluid leaked through the seal in order to ensure proper operation of converter 210 and the transmission. Although converter 210 is disposed in a transmission bell housing (partially shown), the bell housing is generally not sealed to the engine (not shown). Therefore, leakage at the interface between housing 212 and hub 234 may result in hydraulic fluid contamination of the area near the bell housing and in adjacent areas, for example, surfaces below the housing. Rotary shaft seal 246 advantageously provides a liquid-tight seal between housing 212 and hub 234.

Although rotary shaft seal 246 forms a hydraulic seal, the seal may be compromised when increased hydraulic pressure present in converter 210 acts on seal 246. Dynamic seal 248 is designed to operate at the higher pressures associated with operation of converter 210 and can substantially contain the hydraulic pressure during operation of converter 210, but dynamic seal 248 is not an absolute seal and allows some leakage of hydraulic fluid into chamber 256. If allowed to accumulate, fluid in chamber 256 could build pressure in chamber 256 and compromise rotary shaft seal 246, which is not designed to operate at the higher pressures associated with operation of converter 210. Advantageously, hydraulic channel 258 lowers pressure in chamber 256 by providing a discharge path for fluid (not shown) in chamber 256. Channel 258 may be in fluid communication with a sump (not shown) for the transmission, for example.

Portion 234 and portion 240 include overlapping segments 259 and 261, respectively. That is, segments 259 and 261 are axially overlapped so that segment 259 is radially outside of segment 261. In an example embodiment (not shown), segment 259 is radially inside of segment 261. Overlapping segments 259 and 261 form a portion of hydraulic channel 258 at spline connection 263, for example. That is, spline connection 263 has sufficient clearance to allow flow of hydraulic fluid from chamber 256 through the spline connection.

Clutch 266 is disposed in a torque path between portion 240 and housing 212. Impeller shell 242 is connected to backing plate 267 by bolt 269, for example. Housing 212 is connected to inner carrier 272 through damper 273. Inner carrier 272 is engaged with friction plate 274. Hydraulic pressure acting on piston 276 through channel 278 drivingly engages and disengages portion 240 and housing 212.

Portion 234 is for radially positioning the rotor (not shown) relative to transmission 282, as described below. Portion 234 is connected to the rotor (not shown) and includes bearing surface 280. Surface 280 is installed into bushing 284. First portion 234 is radially positioned by bushing 284 disposed in transmission 282. Therefore, the rotor (not shown) is radially positioned relative to transmission 282 by bushing 284 and portion 234. A stator (not shown) of the electric motor is disposed in transmission 282.

The following description is made with reference to FIGS. 1-3. Torque converter 10 includes impeller hub 40 drivingly engaged with electric motor 38. Advantageously, hub 40 can be rotationally connected and disconnected from housing 12 through clutch 66, for example. Torque converter 10 includes hydraulic seal assembly 45 between housing 12 and hub 40, and rotary shaft seal 46 forming a first portion of assembly 45. In an example embodiment, torque converter 10 further includes dynamic seal 48 forming a second portion of assembly 45.

Clutch 66 advantageously permits electric motor 38 to drive the transmission pump (not shown) without rotation of housing 12 and the engine (not shown). Engine idle speed is generally higher than the transmission pump speed necessary to keep the transmission hydraulic system pressurized. The increased speed exacerbates pumping losses in converter 10 when a driving gear is engaged in the transmission and the vehicle is stationary. However, the rotational speed of electric motor 38 is variable and can be used to more precisely control the transmission pump output. Clutch 66 advantageously permits lower speed rotation by motor 38 to reduce losses in converter 10 when the vehicle is stationary.

The discussion regarding torque converter 10 and clutch 66 is applicable to torque converter 210 and clutch 266.

Torque converter 10 also includes transmission hub 34 fixedly attached to electric motor 38 and radially positioned by bearing 84 disposed in transmission 82. Torque converter 210 includes transmission hub 234 fixedly attached to electric motor (not shown) and radially positioned by bushing 284 disposed in transmission 282. Radial positioning of the electric motor in the transmission advantageously lowers tolerance variation to precisely position electric motor components relative to one another. In an example embodiment, impeller hub 40 and transmission hub 34, or 240 and 234, are drivingly engaged.

According to an example aspect of the invention, a method of assembling a torque converter (e.g., torque converter 10 or 210) to a transmission (e.g., transmission 82 or 282) is provided that comprises installing a stator for an electric motor (e.g., stator 86) in the transmission, affixing a first impeller hub (e.g., hub 34 or 234) to a rotor for the electric motor (e.g., rotor 36), and installing the rotor into the stator. In some example embodiments, the method also includes radially positioning the hub in the transmission (e.g., with bearing 84 or bushing 284). In some example embodiments, the method also includes affixing a second impeller hub (e.g., hub 40 or 240) to the torque converter and connecting the first and second impeller hubs so they are drivingly engaged (e.g., with spline 263).

Although example aspects of this invention have been described in certain specific embodiments, many additional modifications and variations would be apparent to those skilled in the art. It is therefore to be understood that this invention may be practiced otherwise than as specifically described. Thus, the present example embodiments of the invention should be considered in all respects as illustrative and not restrictive.

We claim:

1. An impeller hub assembly comprising:
a first portion connected to a rotor for an electric motor;
a second portion connected to an impeller shell of a torque converter; and
a rotary shaft seal for hydraulically sealing at least one of the first and second portions of the impeller hub assembly to a housing for the torque converter.

2. The impeller hub assembly of claim 1, further comprising:
a dynamic seal;
a hydraulic chamber at least partially enclosed by the rotary shaft seal and the dynamic seal; and
a hydraulic channel in fluid communication with the chamber.

3. The impeller hub assembly of claim 2, wherein the hydraulic channel is for lowering pressure in the chamber by providing a discharge path for fluid in the chamber.

4. The impeller hub assembly of claim 3, wherein the first and second portions comprise respective overlapping segments forming at least a portion of the hydraulic channel.

5. The impeller hub assembly of claim 3, further comprising a sleeve installed into the first or second portion of the impeller hub and forming at least a portion of the hydraulic channel.

6. The impeller hub assembly of claim 5, wherein the first and second portions of the impeller hub comprise respective radially displaced holes in fluid communication.

7. The impeller hub assembly of claim 1, further comprising a clutch disposed in a torque path between the second portion and the housing.

8. The impeller hub of claim 1, wherein the first portion is for radially positioning the rotor relative to a transmission.

9. The impeller hub of claim 8, wherein the first portion is radially positioned by a bearing or bushing disposed in the transmission.

10. The impeller hub of claim 9, wherein a stator of the electric motor is disposed in the transmission.

11. A torque converter comprising:
an impeller hub drivingly engaged with an electric motor; and
a housing that can be rotationally connected and disconnected from the impeller hub.

12. The torque converter of claim 11, further comprising:
a hydraulic seal assembly between the housing and the hub, wherein the hydraulic seal assembly includes a rotary shaft seal for forming a first portion of the seal assembly.

13. The torque converter of claim 12, wherein the hydraulic seal assembly includes a dynamic seal for forming a second portion of the seal assembly.

14. The torque converter of claim 11, further comprising a transmission hub fixedly attached to an electric motor and radially positioned by a bearing or a bushing disposed in a transmission.

15. The torque converter of claim 14, wherein the impeller hub and the transmission hub are drivingly engaged.

16. A method of assembling a torque converter to a transmission comprising:
installing a stator for an electric motor in the transmission;
affixing a first impeller hub to a rotor for the electric motor;
installing the rotor into the stator and radially positioning the hub in the transmission;
affixing a second impeller hub to the torque converter; and,
connecting the first and second impeller hubs so they are drivingly engaged.
